(19) United States
(12) Patent Application Publication
(10) Pub. No.: US 2020/0234170 A1
(43) Pub. Date: Jul. 23, 2020

(54) METHOD FOR CLASSIFYING ECO-GEOLOGICAL ENVIRONMENT TYPES BASED ON COAL RESOURCE EXPLOITATION

(71) Applicant: CHINA UNIVERSITY OF MINING AND TECHNOLOGY, Xuzhou (CN)

(72) Inventors: Wenping LI, Xuzhou (CN); Zhi YANG, Xuzhou (CN); Qiqing WANG, Xuzhou (CN); Wei QIAO, Xuzhou (CN); Xiaoqin LI, Xuzhou (CN)

(73) Assignee: CHINA UNIVERSITY OF MINING AND TECHNOLOGY, Xuzhou (CN)

(21) Appl. No.: 16/639,138

(22) PCT Filed: Jan. 25, 2019
(86) PCT No.: PCT/CN2019/073160

§ 371 Date: Feb. 14, 2020

(30) Foreign Application Priority Data
Jan. 30, 2018 (CN) 201810089353.1

(51) Int. Cl. G06N 7/02; G06F 17/16; G06F 17/18; G06Q 10/06

(52) U.S. Cl. CPC G06N 7/023; G06Q 10/0639; G06F 17/18; G06F 17/16

(57) ABSTRACT

A method for classifying eco-geological environment types based on coal resource exploitation solves the problem in the prior art of a lack of combined consideration of different geological and ecological environments on the surface in a to-be-mined area before coal mining. Based on surveys of ecological, hydrological, and geological information of the area, and by means of a Fuzzy Delphi Analytic Hierarchy Process (FDAHP) and weighted fuzzy C-means clustering, the present invention determines different eco-geological environment types. According to the existing ecological, hydrological, and geological information, the present invention can rapidly and effectively classify the different eco-geological environment types, and further determine eco-geological features and their sensitivity to coal resource exploitation.

### CROSS REFERENCES TO THE RELATED APPLICATIONS

This application is the national phase entry of International Application No. PCT/CN2019/073160, filed on Jan. 25, 2019, which is based upon and claims priority to Chinese Patent Application No. 201810089353.1, filed on Jan. 30, 2018, the entire contents of which are incorporated herein by reference.

### TECHNICAL FIELD

The present invention relates to the field of eco-geological environmental protection, and in particular, to a method for classifying eco-geological environment types based on coal resource exploitation.

### BACKGROUND

As an important natural resource, the coal resource is a basic source of energy and materials for many industries such as steel, cement, and chemicals, and accounts for more than 70% of China's primary resource consumption. With the gradual depletion of the coal resource in eastern China, the coal industry rapidly shifts its key development area to western China. In the next 10 years, coal production in five western provinces including Shanxi, Shaanxi, Inner Mongolia, Ningxia and Xinjiang will exceed 70% of China's total coal production. However, characterized by low average rainfall of many years and huge water evaporation, the western China belongs to an arid/semi-arid area, with poor water resources and a fragile ecological environment. Moreover, in recent years, the large-scale exploitation of the coal resources in this area, especially the exploitation of the first mining seam of shallow depth, brings a series of geological environment problems to mines, among which a groundwater level drop becomes particularly prominent. Consequently, wells dry up, the surface runoff is reduced, and the basin ecology on both sides of a river is seriously damaged, incurring a decline in the quality of the eco-geological environment. Especially in recent years, the eco-geological environment problems have attracted great attention from the people and the country. Therefore, the guide to 973 Program in 2014 incorporates “scientific-scale exploitation of coal resource and protection of water resource in ecologically fragile regions of western China” into one of funded research directions in “the field of energy science”.

A study of the eco-geological environment aims to find out the relationship between the geological environment and ecology, including impacts of different geological bodies, geological processes, environmental changes, biological effects, and biological activities (mainly human activities) on the geological environment. In the arid and semi-arid ecologically fragile regions in western China, the large-scale coal exploitation has a significant impact on the occurrence of water resources in the phreatic aquifer. Because coal mining may cause surface cracking and subsidence, a serious water inrush is likely to happen, resulting in a significant drop of the phreatic level. The drop of the phreatic level further affects the surface vegetation, since plants are unable to absorb the moisture from the phreatic aquifer. Thus, if the phreatic level continues to drop, the eco-geological environment may deteriorate. Therefore, the surface run-off and the phreatic water in a loose sandy layer are bridges linking geology and ecology, and reveal important ecological functions. However, sensitivity of different types of the eco-geological environment to a mining activity is different. Regions with a poor eco-geological environment are less sensitive to the coal mining activity, while regions with a good eco-geological environment are highly sensitive to even a small-scale mining activity. Therefore, it is necessary to classify eco-geological environment types according to different features of the eco-geological environment. Such classification can lay foundation for tasks such as protecting valuable water resources in the phreatic aquifer, maintaining the originally fragile eco-geological environment, making plans for a mining area, and selecting an appropriate exploitation mode, thus being of great significance for coal mining under ecological environmental protection in the arid and semi-arid regions.

At the present stage, domestic and foreign technologies mostly concentrate on monitoring, evaluation and restoration measures to deal with the destruction of the original surface geological environment or ecological environment after completion of coal mining activities, but lack differentiation among different eco-geological environment types in combined consideration of different geological and ecological environments on the surface in a to-be-mined area before the coal mining activities, so as to provide related data for a specific coal mining activity according to different eco-geological environment conditions. Thus, exploitation of the coal resource can be implemented while damage to the surface eco-geological environment can be reduced as much as possible. Furthermore, a necessary foundation can be laid for future restoration and remediation of the surface eco-geological environment in a mining area, realizing coordinated development of coal resource exploitation and eco-geological environmental protection.

There are many complicated factors which affect the eco-geological environment. These factors are interrelated and mutually influential, and have different overall impacts on the eco-geological environment. In addition, the various factors affecting the eco-geological environment mostly have features of data fuzziness, evaluation standard fuzziness, and the like. Therefore, based on the theory of fuzzy mathematics, and by using ArcGIS and MATLAB as computing platforms, a hierarchical structure model for classification of eco-geological environment types is established to classify the eco-geological environment in the western arid and semi-arid ecologically fragile regions into different types.

Weight coefficients of the classification results can be calculated in an objective approach or a subjective approach. The objective approach mainly includes an entropy weight method, a principal component analysis method, and a mean square error method. The subjective approach mainly includes a direct scoring method, an expert scoring method, an analytic hierarchy process, a decision alternative ratio evaluation method, and a comparison-based sorting method. However, factor indicators related to the classification of the eco-geological environment types mostly have inexact and fuzzy values, thus failing to meet the calculation requirements of the objective approach. For this problem, the analytic hierarchy process, as a system analysis technique combining qualitative analysis and quantitative analysis in the subjective approach, is widely applied, since it can decompose a complicated problem into a hierarchy to quantify qualitative conditions. However, the conventional analytic hierarchy process requires a consistency check which is difficult and does not allow a decision maker to make largely inconsistent judgments. In fact, from the perspective of behavioral decision analysis, the decision maker should be allowed to make largely inconsistent judgments. A Fuzzy Delphi Analytic Hierarchy Process (FDAHP) combines the analytic hierarchy process, a fuzzy evaluation principle, and a Delphi group decision-making method. It is a decision-making technique which enables the decision maker to fully participate in weight determining and analysis, to form an interactive weight vector determining and analysis procedure, and to finally determine a group decision weight vector satisfying the decision maker. Such a decision making and interaction procedure can be carried out under any single criterion of the hierarchical structure. Moreover, this technique allows the decision maker to make inappropriate judgments, and a consistency check is not required for a judgment matrix. Therefore, it is needed to quantitatively evaluate classification indicators more precisely, to provide a more accurate scientific basis for rational classification of the eco-geological environment.

The concept of clustering is proposed by Everitt in 1974, who pointed out that clustering is a task of grouping data into a specified number of clusters in a particular way, such that items in the same cluster are as similar as possible, while items belonging to different clusters are as dissimilar as possible. Clustering is widely applied in projects such as statistics, image processing, and the like, to solve many problems. It is achieved by various algorithms mainly including a model-based clustering algorithm, a partitioning clustering algorithm, a hierarchical clustering algorithm, and the like. Each algorithm has its own characteristics. The diversification and complication of practical problems in a project determine that no algorithm can solve all problems. However, with the development of computer technology, it is becoming increasingly easier to realize digital computing and program implementation. Therefore, clustering based on objective functions is further developed and popularized. Fuzzy clustering belongs to such an algorithm, which introduces the fuzzy theory based on K-means clustering. By addition of weights of different attributes to the fuzzy C-means clustering algorithm, an attribute-weighted fuzzy C-means clustering algorithm is formed, which is more accurate and scientific.

### SUMMARY

In view of the foregoing analysis, the present invention aims to provide a method for classifying eco-geological environment types based on coal resource exploitation, which lays the foundation for tasks such as protecting valuable water resources in the phreatic aquifer, maintaining the originally fragile eco-geological environment, making plans for a mining area, and selecting an appropriate exploitation mode, thus being of great significance for coal mining under ecological environmental protection in the arid and semi-arid regions.

The objective of the present invention is achieved mainly by using the following technical solutions:

A method for classifying eco-geological environment types based on coal resource exploitation includes the following steps:

step 1: acquiring ecological, hydrological, and geological information of an area;

step 2: establishing a hierarchical structure model for classification of eco-geological environment types;

step 3: selecting relevant factors affecting the eco-geological environment as classification indicators according to the information acquired in step 1 and the hierarchical structure model established in step 2; and acquiring ecological, hydrological, and geological data corresponding to all the classification indicators participating in type classification in the hierarchical structure model for classification of eco-geological environment types of a to-be-classified region;

step 4: converting the data related to classification indicators acquired in step 3 into floating-point data;

step 5: making the floating-point data obtained in step 4 dimensionless by using a normalization function;

step 6: analyzing and calculating a weight coefficient of each classification indicator by means of an FDAHP;

step 7: combining the dimensionless data obtained in step 5 and the weight coefficients obtained in step 6, and performing superimposed clustering computation for influence factors by means of weighted fuzzy C-means clustering; and

step 8: performing analysis and judgment based on clustering computation results obtained in step 7 and ecological, hydrological, and geological features of the classification indicators, to determine different eco-geological environment types and obtain a zoning map based on the eco-geological environment types.

Further, the hierarchical structure model described in step 2 comprises a goal layer and an indicator layer, the goal layer indicates a general goal of the classification of eco-geological environment types, and the indicator layer is composed of all indicators participating in type classification.

Further, the normalization function for the dimensionless processing in step 5 is as follows:

$${f}_{i} = a + ( b - a ) \frac{{x}_{i} - min ( {x}_{i} )}{max ( {x}_{i} ) - min ( {x}_{i} )} , ( i = 1 , 2 , … n )$$

wherein in the formula, fᵢ is the ith dimensionless data in each classification indicator; a and b are respectively the lower limit and the upper limit of a normalization range, n pieces of data existing in each classification indicator; xᵢ is the ith original data before the dimensionless processing in each classification indicator; and max(xᵢ) and min(xᵢ) are respectively a maximum value and a minimum value of the original data in each classification indicator.

The dimensionless processing can remove the influence of dimensions on clustering computation in subsequent steps.

Further, the lower limit a of the normalization range is 0 and the upper limit b of the normalization range is 1.

Further, step 6 is specifically as follows: by consulting experts in ecological, hydrological, and geological fields, and by using the FDAHP and a T.L.Saatyl-9 scaling method in combination, scoring each classification indicator for its overall importance to the eco-geological environment, establishing a group fuzzy judgment matrix, determining a group fuzzy weight vector, and finally calculating a weight coefficient of each classification indicator by means of single-criterion weight analysis.

Further, step 6 specifically includes the following steps:

Step 6.1: m classification indicators to be judged and n consulting experts in related fields are set. By means of the Delphi expert survey, the consulting experts in related fields score the classification indicators in the indicator layer for relative importance to the goal layer under a particular criterion, wherein the relative importance between the ith classification indicator Fᵢ and the jth classification indicator Fⱼ that is judged by the kth expert is B_{ij·k}, i=1, 2, . . . m, j=1, 2, . . . m, and k=1, 2 . . . n. A pairwise comparison judgment matrix B(k)=[B_{ij·k}] of the kth expert is determined:

$$B ( k ) = [ {B}_{ij \cdot k} ] = [ \begin{matrix}{B}_{ij \cdot k} & \text{?} & … & {B}_{ij \cdot k} & … & \text{?} \\ \text{?} & \text{?} & … & {B}_{2 j \cdot k} & … & \text{?} \\ ⋮ & ⋮ & ⋱ & ⋮ & ⋮ & ⋮ \\ \text{?} & \text{?} & … & {B}_{ij \cdot k} & … & \text{?} \\ ⋮ & ⋮ & … & ⋮ & ⋱ & ⋮ \\ {B}_{mi \cdot k} & {B}_{m 2 \cdot k} & … & {B}_{mj \cdot k} & … & \text{?}\end{matrix} ] , \\ i = 1 … m , j = 1 … m and k = 1 … n , \\ \text{?} \text{indicates text missing or illegible when filed}$$

wherein B_{ij·k}=P_{i·k}/P_{j·k}, P_{i·k} is a score of the ith classification indicator for its importance to the goal layer that is given by the kth expert, and P_{j·k} is a score of the jth classification indicator for its importance to the goal layer that is given by the kth expert.

Step 6.2: A group pairwise fuzzy judgment matrix C, expressed by using triangular fuzzy numbers, of all the consulting experts in related fields is established:

C=[αᵢⱼ,βᵢⱼ,γᵢⱼ]=[B₁B₂. . . Bₘ]

wherein in the formula, the judgment matrix is composed of three computing elements: αᵢⱼ, βᵢⱼ, and γᵢⱼ, i=1 . . . m, j=1 . . . m, αᵢⱼ≤βᵢⱼ≤γᵢⱼ, and αᵢⱼ, βᵢⱼ, γᵢⱼΣ[1/9, 1]U[1, 9]; and the computing elements αᵢⱼ, βᵢⱼ, and γᵢⱼ are determined by using the following formulas:

$${a}_{ij} = min ( {B}_{i , j} \cdot k ) , k = 1 , 2 , … , n , \\ {β}_{ij} = geomean ( {B}_{ij \cdot k} ) = ( {\prod }_{k = 1}^{m} {B}_{ij \cdot k} ) , k = 1 , 2 , … , n , \\ {γ}_{ij} = max ( {B}_{ij \cdot k} ) , k = 1 , 2 , … , n ,$$

wherein k=1, 2 . . . n, n being the total number of the consulting experts in related fields; min(B_{ij·k}) is a minimum value in scores given by all the consulting experts in related fields; geomean(B_{ij·k}) is a geometric mean of the scores given by all the consulting experts in related fields; and max(B_{ij·k}) is a maximum value in the scores given by all the consulting experts in related fields.

Thus, a group pairwise fuzzy judgment matrix of all the consulting experts in related fields is established:

$$C = [ \begin{matrix}( 1 , 1 , 1 ) & ( \text{?} ) & ( \text{?} ) & … & ( \text{?} ) & ( \text{?} ) \\ ( \text{?} ) & ( 1 , 1 , 1 ) & ( \text{?} ) & … & ( \text{?} ) & ( \text{?} ) \\ ( \text{?} ) & ( \text{?} ) & ( 1 , 1 , 1 ) & … & ( \text{?} ) & ( \text{?} ) \\ ⋮ & ⋮ & ⋮ & ⋱ & ⋮ & ⋮ \\ ( \text{?} ) & ( \text{?} ) & ( \text{?} ) & ⋮ & ( 1 , 1 , 1 ) & ( \text{?} ) \\ ( \text{?} ) & ( \text{?} ) & ( \text{?} ) & … & ( \text{?} ) & ( 1 , 1 , 1 )\end{matrix} ]$$

$$\text{?} \text{indicates text missing or illegible when filed}$$

Step 6.3: For any classification indicator Fᵢ in all the classification indicators, a process calculation vector rᵢ involved in determining a group fuzzy weight vector is calculated:

$${r}_{i} = {( {b}_{i 1} ⊗ {B}_{i 2} ⊗ … ⊗ {B}_{im} )}^{\frac{1}{m}} ,$$

Then, a group fuzzy weight vector regarding any classification indicator Fᵢ is determined as follows:

wᵢ=rᵢ⊗(r₁⊕r₂⊕. . . ⊕rₘ)⁻¹,

wherein in the formula, the symbols ⊗ and ⊕ are respectively multiplication and addition operations of the triangular fuzzy numbers.

The operation of the triangular fuzzy numbers is described as follows:

a=[a₁, a₂, a₃] and b=[b₁, b₂, b₃] are set as two positive triangular fuzzy numbers, and the following formulas can be obtained according to a theory regarding triangular fuzzy numbers:

$$a ⊕ b = [ {a}_{1} + {b}_{1} , {a}_{2} + {b}_{2} , {a}_{3} + {b}_{3} ] , \\ a ⊗ b = [ {a}_{1} \times {b}_{1} , {a}_{2} \times {b}_{2} , {a}_{3} \times {b}_{3} ] , \\ and$$

$${a}^{- 1} = [ \frac{1}{{a}_{3}} , \frac{1}{{a}_{2}} , \frac{1}{{a}_{1}} ] ;$$

wherein a₁, a₂, a₃ and b₁, b₂, b₃ are two sets of any real numbers.

Step 6.4: A group fuzzy weight vector regarding any classification indicator Fᵢ is determined as follows:

wᵢ=(wᵢ^{L},wᵢ^{M},wᵢ^{U}),

wherein in the formula, wᵢ^{L}, wᵢ^{M}, and wᵢ^{U} are respectively a minimum value, an intermediate value, and a maximum value in the group fuzzy weight vector results regarding the ith classification indicator Fᵢ that are calculated in step 6.3.

Then, after normalization processing, a weight coefficient Wᵢ of any classification indicator Fᵢ is determined as follows:

$${W}_{i} = \frac{\sqrt[3]{{w}_{i}^{L} \times {w}_{i}^{M} \times {w}_{i}^{U}}}{{\sum }_{i} \sqrt[3]{{w}_{i}^{L} \times {w}_{i}^{M} \times {w}_{i}^{U}}} .$$

Further, step 7 includes the following steps:

step 7.1: setting a sample collection X to be subjected to clustering and having n pieces of d-dimensional vector data, wherein X={x₁, x₂, x₃, . . . xₙ}; grouping the sample collection into c clusters Gᵢ(i=1, . . . , c), i being the ith cluster; randomly selecting c data points from the sample data as an initial cluster center, and xₖ={xₖ₁, xₖ₂, xₖ₃, . . . , x_{kd}}^{T}∈R^{d}(k=1, . . . c), xₖⱼ being a value assigned to the jth-dimension attribute of a data point xₖ; and setting values of a weighted index m, an objective function iteration termination threshold ε, and the maximum number of iterations before termination, 1;

step 7.2: calculating a weighted Euclidean distance d_{w-ij} from each data point in each sample to the cluster center;

step 7.3: calculating the membership degree of data in each sample with respect to each cluster;

step 7.4: calculating a new cluster center matrix P; and

step 7.5: repeating steps 7.2, 7.3, and 7.4; and for each data point in each sample indicator, when a difference value between a new cluster center matrix P^{(t)} calculated in the tth iteration and a new cluster center matrix P^{(t+1)} calculated in the (t+1)th iteration is less than the set iteration termination threshold ε, that is, ∥P^{(t+1)}−P^{(t)}≤ε, or the number of iterations reaches the set maximum number 1, stopping calculation.

Further, in step 7.1, the weighted index m is 2, and the iteration termination threshold c is taken from 0.001 to 0.01.

Further, step 7.2 includes the following sub-steps:

sub-step 7.2.1: grouping the sample collection X={x₁, x₂, x₃, . . . xₙ} having n sample data points xₖ(k=1, . . . , n) into c clusters Gᵢ(i=1, . . . , c); randomly selecting c data points from data points xₖ(k=1, . . . , n) in each sample as an initial cluster center of each cluster, wherein xₖ={xₖ₁, xₖ₂, xₖ₃, . . . , x_{kd}}^{T}∈R^{d}(k=1, . . . c), and xₖⱼ is a value assigned to the jth-dimension attribute of a data point xₖ; and calculating a distance from each data point in each sample to the initial cluster center cᵢ(i=1, . . . c), and calculating the sum of squared errors (SSE) from the data points in each sample to the initial cluster center; and

sub-step 7.2.2: multiplying the Euclidean distance dₖᵢ=∥xₖ−cᵢ∥ from each data point in each sample to the initial cluster center by the weight coefficient Wᵢ calculated in step 6.4, for modification:

Euclidean distance:

$${d}_{ki} = d ( {x}_{k} - {c}_{i} ) = ‖ {x}_{k} - {c}_{i} ‖ = \sqrt{{\sum }_{j = 1}^{d} {( \text{?} - {c}_{ij} )}^{2}} , \\ \text{?} \text{indicates text missing or illegible when filed}$$

and

weighted Euclidean distance: d_{x- ij}=d∥xⱼ−cᵢ∥ᵥ=[(xⱼ−cᵢ)^{T}W²(xⱼ−cᵢ]^{1/2},

wherein the weight vector W consists of the weight coefficient Wᵢ calculated in step 6.4, that is, the weight vector W=[Wᵢ, W₂, . . . Wᵢ]^{T}, (i=1 . . . d), and the weight coefficient Wᵢ in the weight vector shall meet the following formula:

$${W}_{i} \geq 0 , i = ( 1 , 2 , … , d ) and {\sum }_{i = 1}^{d} {W}_{i} = 1.$$

Further, step 7.3 includes the following sub-steps:

sub-step 7.3.1: setting a new SSE criterion function for evaluation of clustering performance, namely, a new weighted objective function:

$${J}_{WFCM} = {\sum }_{i = 1}^{c} {\sum }_{j = 1}^{n} {u}_{ij}^{m} {‖ {x}_{j} - {c}_{i} ‖}_{w}^{2} = {\sum }_{i = 1}^{c} {\sum }_{j = 1}^{n} {u}_{ij}^{m} {d}_{w - ij}^{2} ;$$

$$wherein$$

$${u}_{ij} = \{ \begin{matrix}1 & k \neq i , if {‖ {x}_{j} - {c}_{i} ‖}^{2} \leq {‖ {x}_{j} - {c}_{k} ‖}^{2} \\ 0 & under other conditions\end{matrix} ;$$

sub-step 7.3.2: performing solution calculation by using the Lagrangian multiplier method, to create a new Lagrangian function:

$$J ( U , P , {λ}_{1} , … , {λ}_{n} ) = {J}_{WFCM} ( U , P ) + {\sum }_{j = 1}^{n} {λ}_{j} ( {\sum }_{i = 1}^{c} {u}_{ij} - 1 ) = {\sum }_{i = 1}^{c} {\sum }_{j = 1}^{n} {u}_{ij}^{m} {d}_{w - ij}^{2} + {\sum }_{j = 1}^{n} {λ}_{j} ( {\sum }_{i = 1}^{c} {u}_{ij} - 1 ) ,$$

wherein in the formula, U is a weighted fuzzy partition matrix, P is a new cluster center matrix, uᵢⱼ is the membership degree of the jth data point with respect to the cluster Gᵢ, cᵢ is a cluster center of a corresponding fuzzy vector set, and λⱼ is a Lagrangian multiplier of n constraint formulas; and

with reference to a constraint condition

$$\text{?} \text{?} = 1 {∀}_{j} = 1 , … n , \\ \text{?} \text{indicates text missing or illegible when filed}$$

calculating a partial derivative for the input parameters m=2 and 0.001≤ε≤0.01, to obtain a necessary condition for the new weighted objective function J_{WFCM} to reach a minimum value:

$${u}_{w - ij} = \{ \begin{matrix}\frac{1}{{\sum }_{k = 1}^{c} {( \frac{{d}_{w - ij}}{{d}_{w - kj}} )}^{2 / ( m - 1 )}} & {d}_{w - kj} > 0 ( 1 \leq j \leq c ) \\ 1 & {d}_{w - ij} = 0 ( 1 \leq i \leq c ) \\ 0 & ∃ j , j \neq i , {d}_{w - kj} = 0\end{matrix} and {c}_{w - i} \frac{{\sum }_{j = 1}^{n} {u}_{w - ij}^{m} {x}_{j}}{{\sum }_{j = 1}^{n} {u}_{w - ij}^{m}} ;$$

and

sub-step 7.3.3: determining the membership degree of a data point with respect to a certain cluster according to the maximum membership principle where the data point belongs to a cluster having the maximum membership degree as shown in the following expression:

$$k = {arg max}_{i = 1 , … , c} {u}_{ij} .$$

The present invention achieves the following advantageous effects:

The present invention provides a method for classifying eco-geological environment types based on coal resource exploitation. The method aims to classify arid and semi-arid regions rich in coal resources but having a fragile eco-geological environment in Northwest China into different eco-geological environment types, and draw a zoning map based on the eco-geological environment types. Thus, the present invention can lay foundation for tasks such as protecting valuable water resources in the phreatic aquifer, maintaining the originally fragile eco-geological environment, making plans for a mining area, and selecting an appropriate exploitation mode, thus being of great significance for coal mining under ecological environmental protection in the arid and semi-arid regions.

According to the existing ecological, hydrological, and geological information, the present invention can rapidly and effectively classify the different eco-geological environment types, and further determine eco-geological features of the different types of the eco-geological environment and their sensitivity to coal resource exploitation. In this way, the present invention provides a scientific basis for selecting an appropriate coal mining mode to realize exploitation and utilization of the coal resource while the valuable phreatic resources in the arid and semi-arid regions are protected and the ecologically fragile environment is maintained, thus being of great significance for coal mining under water-containing condition in the ecologically fragile regions in Northwest China.

The present invention considers different geological and ecological environments on the surface in a to-be-mined area in combination, and makes differentiation among different eco-geological environment types, so as to provide related data for a specific coal mining activity according to different eco-geological environment conditions. Thus, exploitation of the coal resource can be implemented while damage to the surface eco-geological environment can be reduced as much as possible. Furthermore, a necessary foundation can be laid for future restoration and remediation of the surface eco-geological environment in the mining area, realizing coordinated development of coal resource exploitation and eco-geological environmental protection.

In the present invention, the above technical solutions can also be combined with each other to achieve more preferred combination schemes. Other features and advantages of the present invention will be set forth in the following description. Some advantages are apparent from the description or can be understood by implementation of the present invention. The objectives and other advantages of the present invention can be achieved and obtained from the contents specifically pointed out in the description, the appended claims, and the accompanying drawings.

### BRIEF DESCRIPTION OF THE DRAWINGS

The accompanying drawings are only used for the purpose of illustrating a specific embodiment, and are not considered as a limitation to the present invention. Throughout the accompanying drawings, identical reference numerals indicate identical parts.

FIG. 1 is a flowchart of implementation of a method of the present invention;

FIG. 2 shows a hierarchical structure model for classification of eco-geological environment types in a to-be-classified region;

FIG. 3 is a thematic map of a vegetation index involved in classification of the eco-geological environment types;

FIG. 4 is a thematic map of a surface elevation involved in classification of the eco-geological environment types;

FIG. 5 is a thematic map of a terrain slope involved in classification of the eco-geological environment types;

FIG. 6 is a thematic map of surface lithology involved in classification of the eco-geological environment types;

FIG. 7 is a thematic map of a landform type involved in classification of the eco-geological environment types;

FIG. 8 is a thematic map of a degree of influence of a hydrographic net involved in classification of the eco-geological environment types;

FIG. 9 is a thematic map of a normalized vegetation index involved in classification of the eco-geological environment types;

FIG. 10 is a thematic map of a normalized surface elevation involved in classification of the eco-geological environment types;

FIG. 11 is a thematic map of a normalized terrain slope involved in classification of the eco-geological environment types;

FIG. 12 is a thematic map of normalized surface lithology involved in classification of the eco-geological environment types;

FIG. 13 is a thematic map of a normalized landform type involved in classification of the eco-geological environment types;

FIG. 14 is a thematic map of a normalized degree of influence of a hydrographic net involved in classification of the eco-geological environment types; and

FIG. 15 is a zoning map based on the eco-geological environment types.

### DETAILED DESCRIPTION OF THE EMBODIMENTS

A preferred embodiment of the present invention is specifically described below with reference to the accompanying drawings. The accompanying drawings form a part of the present application and are used to illustrate the principle of the present invention together with the embodiment of the present invention and are not intended to limit the scope of the present invention.

The present invention is further described below by using a specific embodiment with reference to FIG. 1.

As shown in FIG. 1, a method for classifying eco-geological environment types based on coal resource exploitation includes the following steps:

1. Ecological, hydrological, and geological information of an area are collected.

2. A hierarchical structure model for classification of eco-geological environment types is established, which includes a goal layer and an indicator layer. The goal layer indicates a general goal of the classification of eco-geological environment types, and the indicator layer is composed of all indicators participating in type classification.

3. Relevant factors affecting the eco-geological environment are selected as classification indicators according to the information acquired in step 1 and the hierarchical structure model established in step 2; and ecological, hydrological, and geological data corresponding to all the indicators participating in type classification in the hierarchical structure model for classification of eco-geological environment types of a to-be-classified region are acquired.

4. The data related to classification indicators acquired in step 3 is processed by ArcGIS into floating-point data .flt readable by MATLAB software.

5. The floating-point data regarding the classification indicators acquired in step 4 is made dimensionless by MATLAB by using a normalization function, to remove the influence of dimensions on clustering computation in subsequent steps.

6. By consulting experts in ecological, hydrological, and geological fields, and by using an FDAHP and a T.L.Saatyl-9 scaling method in combination, each classification indicator for its overall importance to the eco-geological environment is scored, a group fuzzy judgment matrix is established, a group fuzzy weight vector is determined, and finally a weight coefficient of each classification indicator is calculated by means of single-criterion weight analysis.

7. The dimensionless data of the classification indicators acquired in step 5 and the weight coefficient of each classification indicator in its overall importance to the eco-geological environment determined in step 6 are combined in MATLAB, and clustering computation is performed by means of weighted fuzzy C-means clustering, to output different clustering computation results; and these results are stored in the format of a textfile (.txt).

8. The clustering results stored in (.txt) calculated in step 7 are opened in ArcGIS software; and are analyzed and judged based on cluster center values of the factors calculated in step 7 and according to ecological, hydrological, and geological features of the classification indicators, to determine different eco-geological environment types and obtain a zoning map based on the eco-geological environment types.

Step 1 in this embodiment is specifically as follows: A normalized difference vegetation index (NDVI) is extracted by using a remote sensing image. The selected image comes from Landsat8 satellite remote-sensing data, and is formed by means of image mosaicking of two pieces of image data within the scope of a study area. When the satellite collects data after transit, the study area is sunny and the sky is not covered with large clouds. Therefore, the two images both have a low cloud cover, and high imaging quality. The images are clear and have a resolution of 30 m. Based on the digital elevation model data within 30 m, an elevation and a slope of the study area are extracted by using a spatial analysis function of ArcGIS10.5. Through field surveys and accumulation of geological information for many years, the required ecological, hydrological, and geological information are collated.

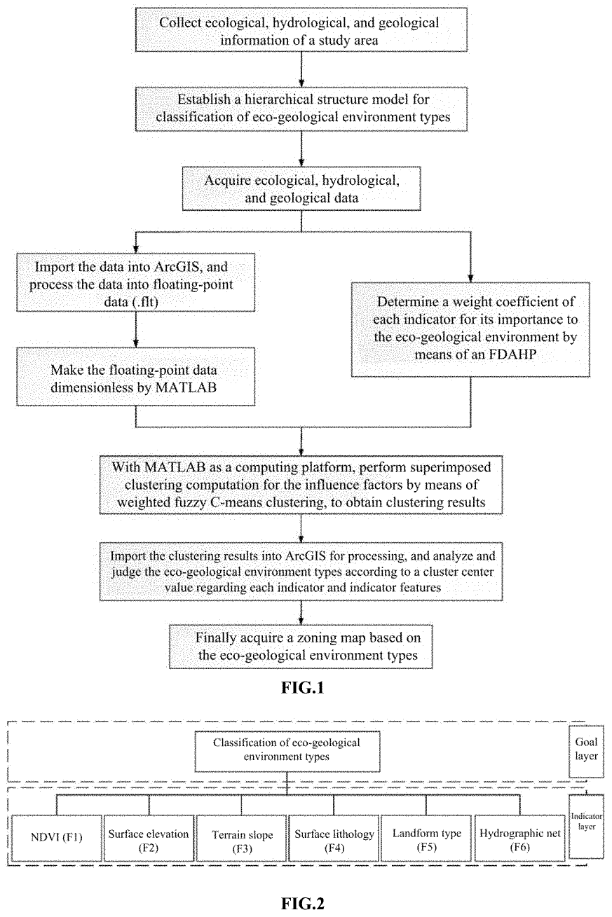

In step 2 of this embodiment, by taking the classification of eco-geological environment types as the goal layer, and the NDVI (F1), surface elevation (F2), terrain slope (F3), surface lithology (F4), landform type (F5), and hydrographic net (F6) as the classification indicators, the hierarchical structure model for classification of eco-geological environment types of a to-be-classified region is established, as shown in FIG. 2.

Subsequently, in step 2, the ecological, hydrological, and geological data corresponding to the six classification indicators are extracted, and step 3 is then performed.

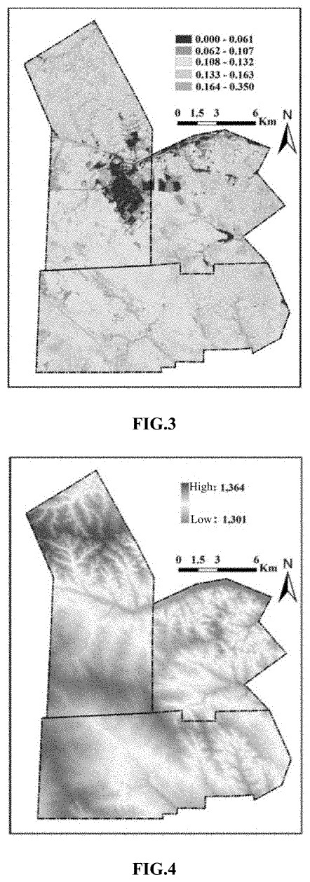

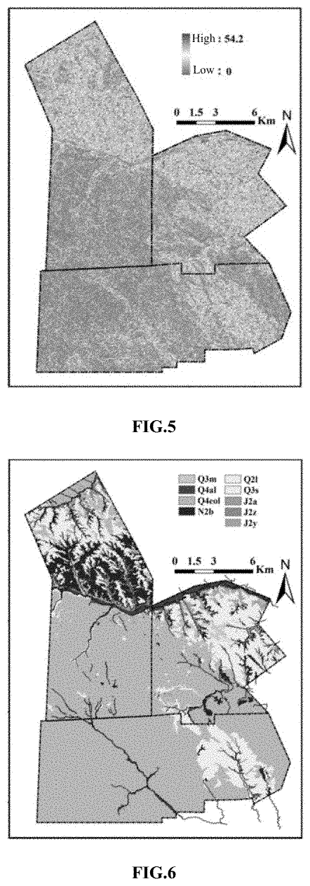

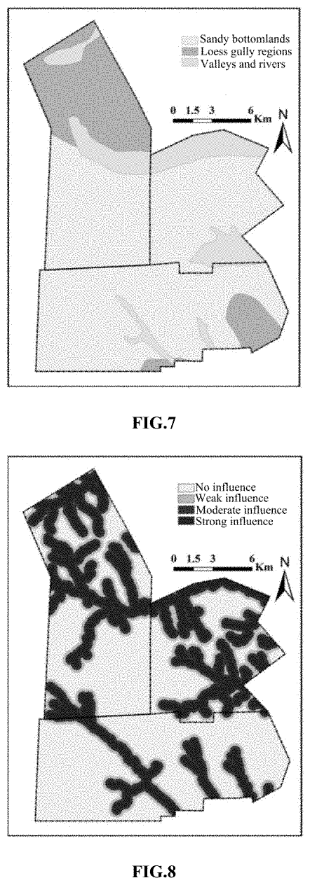

In step 3, the ecological, hydrological, and geological data regarding the to-be-classified region are imported into ArcGIS, to create a single factor map related to each indicator, as shown from FIGS. 3 to 8.

In step 4, by ArcGIS10.5, data in the format of shp in evaluation factors is converted into grid data in the format of grid, and then the grid data is converted into floating-point data .flt readable by MATLAB. A conversion result includes two files. One file is a header file with the expanded name of hdr, including x and y coordinates on the left bottom of the grid, the size of the grid, the number of lines and columns of the grid, and the like. The other file is floating-point data with the expanded name of fit.

Grid processing is performed on the data map related to each individual indicator of the region for which eco-geological environment types are to be classified, to divide the to-be-evaluated region into n basic evaluation units, where n=682*903=615846.

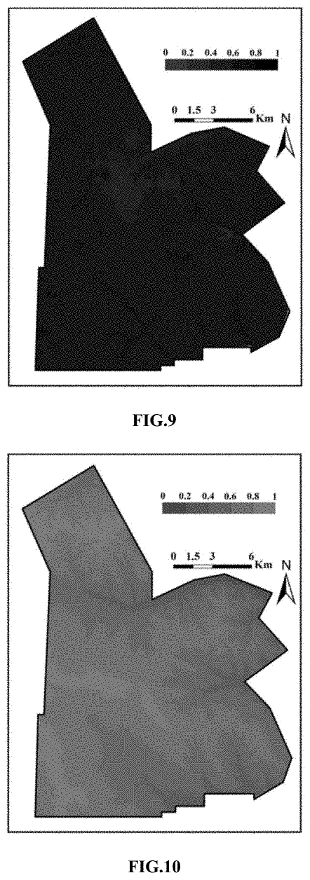

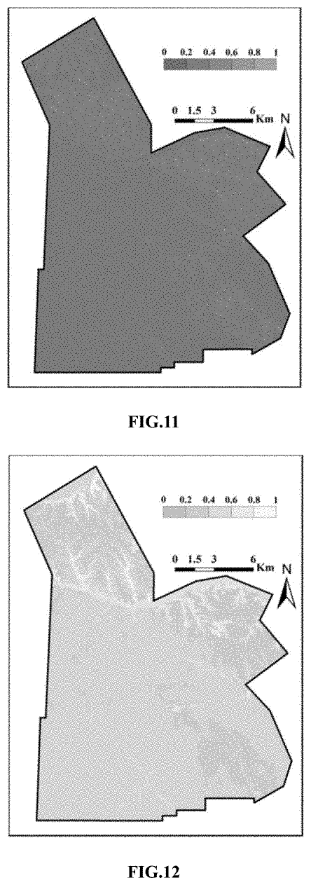

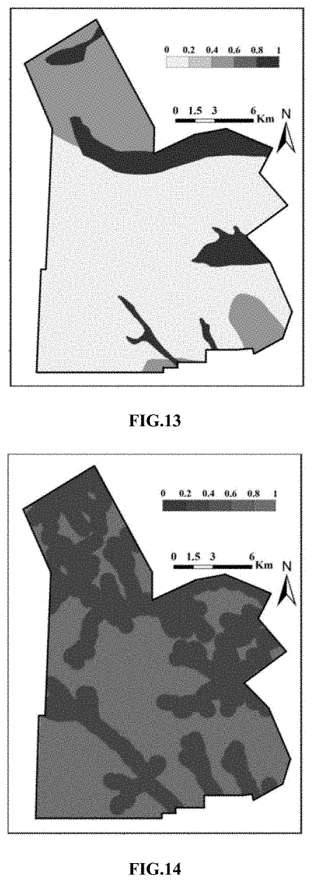

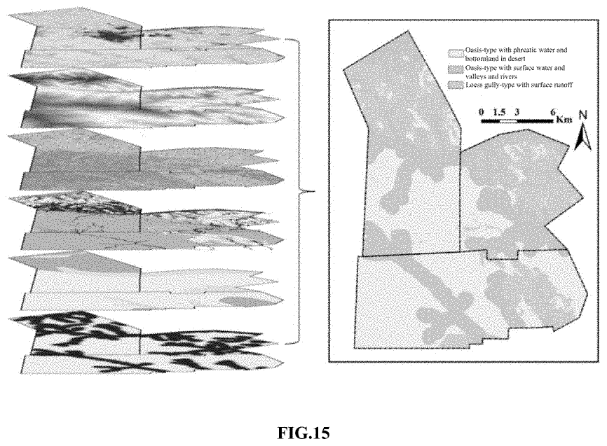

In step 5, in MATLAB, each indicator of the to-be-classified region is read by using the read_AGaschdr function, and the factors are normalized by using a normalization function to achieve a dimensionless effect. FIGS. 9 to 14 show normalization results of the classification indicators.

The normalization function is as follows:

$${f}_{i} = a + ( b - a ) \frac{{x}_{i} - min ( {x}_{i} )}{max ( {x}_{i} ) - min ( {x}_{i} )} , ( i = 1 … n )$$

In the formula, fᵢ is the ith dimensionless data in each classification indicator; a and b are respectively the lower limit and the upper limit of a normalization range; xᵢ is the ith original data before the dimensionless processing in each classification indicator; and max(xᵢ) and min(xᵢ) are respectively a maximum value and a minimum value of the original data in each classification indicator.

Step 6 includes the following steps:

(601): Each classification indicator for its overall importance to the eco-geological environment is scored by using the T.L.Saatyl-9 scaling method:

| Expert | F1 | F2 | F3 | F4 | F5 | F6 |
|---|---|---|---|---|---|---|
| Expert 1(P1) | 3 | 1 | 5 | 8 | 7 | 3 |
| Expert 2(P2) | 3 | 2 | 6 | 9 | 8 | 4 |
| Expert 3(P3) | 3 | 1 | 7 | 8 | 7 | 2 |
| Expert 4(P4) | 4 | 1 | 7 | 7 | 8 | 3 |
| Expert 5(P5) | 3 | 1 | 5 | 8 | 7 | 3 |
| Expert 6(P6) | 4 | 1 | 6 | 8 | 7 | 2 |

(602): A pairwise comparison judgment matrix is established:

$$B ( 1 ) = [ \begin{matrix}1.000 & 3.000 & 0.600 & 0.375 & 0.429 & 1.000 \\ 0.333 & 1.000 & 0.200 & 0.125 & 0.143 & 0.333 \\ 1.667 & 5.000 & 1.000 & 0.625 & 0.714 & 1.667 \\ 2.667 & 8.000 & 1.600 & 1.000 & 1.143 & 2.667 \\ 2.333 & 7.000 & 1.400 & 0.875 & 1.000 & 2.333 \\ 1.000 & 3.000 & 0.600 & 0.375 & 0.429 & 1.000\end{matrix} ]$$

$$B ( 2 ) = [ \begin{matrix}1.000 & 1.500 & 0.500 & 0.333 & 0.375 & 0.750 \\ 0.667 & 1.000 & 0.333 & 0.222 & 0.250 & 0.500 \\ 2.000 & 3.000 & 1.000 & 0.667 & 0.750 & 1.500 \\ 3.000 & 4.500 & 1.500 & 1.000 & 1.125 & 2.250 \\ 2.667 & 4.000 & 1.333 & 0.889 & 1.000 & 2.000 \\ 1.333 & 2.000 & 0.667 & 0.444 & 0.500 & 1.000\end{matrix} ]$$

$$B ( 3 ) = [ \begin{matrix}1.000 & 3.000 & 0.429 & 0.375 & 0.429 & 1.500 \\ 0.333 & 1.000 & 0.143 & 0.125 & 0.143 & 0.500 \\ 2.333 & 7.000 & 1.000 & 0.875 & 1.000 & 3.500 \\ 2.667 & 8.000 & 1.143 & 1.000 & 1.143 & 4.000 \\ 2.333 & 7.000 & 1.000 & 0.875 & 1.000 & 3.500 \\ 0.667 & 2.000 & 0.286 & 0.250 & 0.286 & 1.000\end{matrix} ]$$

$$B ( 4 ) = [ \begin{matrix}1.000 & 4.000 & 0.571 & 0.571 & 0.500 & 1.333 \\ 0.250 & 1.000 & 0.143 & 0.143 & 0.125 & 0.333 \\ 1.750 & 7.000 & 1.000 & 1.000 & 0.875 & 2.333 \\ 1.750 & 7.000 & 1.000 & 1.000 & 0.875 & 2.333 \\ 2.000 & 8.000 & 1.143 & 1.143 & 1.000 & 2.667 \\ 0.750 & 3.000 & 0.429 & 0.429 & 0.375 & 1.000\end{matrix} ]$$

$$B ( 5 ) = [ \begin{matrix}1.000 & 3.000 & 0.600 & 0.375 & 0.429 & 1.000 \\ 0.333 & 1.000 & 0.200 & 0.125 & 0.143 & 0.333 \\ 1.667 & 5.000 & 1.000 & 0.625 & 0.714 & 1.667 \\ 2.667 & 8.000 & 1.600 & 1.000 & 1.143 & 2.667 \\ 2.333 & 7.000 & 1.400 & 0.875 & 1.000 & 2.333 \\ 1.000 & 3.000 & 0.600 & 0.375 & 0.429 & 1.000\end{matrix} ]$$

$$B ( 6 ) = [ \begin{matrix}1.000 & 4.000 & 0.667 & 0.500 & 0.571 & 2.000 \\ 0.250 & 1.000 & 0.167 & 0.125 & 0.143 & 0.500 \\ 1.500 & 6.000 & 1.000 & 0.750 & 0.857 & 3.000 \\ 2.000 & 8.000 & 1.333 & 1.000 & 1.143 & 4.000 \\ 1.750 & 7.000 & 1.167 & 0.875 & 1.000 & 3.500 \\ 0.500 & 2.000 & 0.333 & 0.250 & 0.286 & 1.000\end{matrix} ]$$

(603): A group fuzzy judgment matrix is established:

$${B}_{1} = [ \begin{matrix}1.000 & 1.000 & 1.000 \\ 0.250 & 0.340 & 0.667 \\ 1.500 & 1.800 & 2.300 \\ 1.750 & 2.416 & 3.000 \\ 1.750 & 2.216 & 2.667 \\ 0.500 & 0.833 & 1.333\end{matrix} ] {B}_{2} = [ \begin{matrix}1.500 & 2.942 & 4.000 \\ 1.000 & 1.000 & 1.000 \\ 3.000 & 5.295 & 7.000 \\ 4.500 & 7.109 & 8.000 \\ 4.000 & 6.520 & 8.000 \\ 2.000 & 2.449 & 3.000\end{matrix} ]$$

$${B}_{3} = [ \begin{matrix}0.429 & 0.556 & 0.667 \\ 0.333 & 0.414 & 0.571 \\ 1.000 & 1.000 & 1.000 \\ 1.000 & 1.342 & 1.600 \\ 1.000 & 1.231 & 1.400 \\ 0.286 & 0.463 & 0.667\end{matrix} ] {B}_{4} = [ \begin{matrix}0.375 & 0.451 & 0.571 \\ 0.750 & 1.201 & 2.000 \\ 0.143 & 0.189 & 0.333 \\ 1.000 & 1.000 & 1.000 \\ 0.875 & 0.917 & 1.143 \\ 0.250 & 0.345 & 0.444\end{matrix} ]$$

$${B}_{5} = [ \begin{matrix}0.125 & 0.141 & 0.222 \\ 0.125 & 0.153 & 0.250 \\ 0.333 & 0.408 & 0.500 \\ 0.625 & 0.745 & 1.000 \\ 1.000 & 1.000 & 1.000 \\ 0.286 & 0.376 & 0.500\end{matrix} ] {B}_{6} = [ \begin{matrix}0.714 & 0.812 & 1.000 \\ 1.500 & 2.162 & 3.500 \\ 0.875 & 1.090 & 1.143 \\ 2.250 & 2.902 & 4.000 \\ 2.000 & 2.662 & 3.500 \\ 1.000 & 1.000 & 1.000\end{matrix} ]$$

(604): A group fuzzy weight vector is determined:

W₁=[0.0630.0980.158] W₂=[0.0570.0920.177]

W₃=[0.0900.1430.228] W₄=[0.1770.2850.437]

W₅=[0.1800.2780.419] W₆=[0.0620.1040.173]

(605): A weight coefficient of each classification indicator is determined as follows:

| | | | | | Land- | Hydro- |
|---|---|---|---|---|---|---|
| | | Surface | Terrain | Surface | form | graphic |
| | NDVI | elevation | slope | lithology | type | net |
| Indicator | (W₁) | (W₂) | (W₃) | (W₄) | (W₅) | (W₆) |
| Weight | 0.099 | 0.097 | 0.143 | 0.281 | 0.276 | 0.104 |

In step 7, a clustering function custom_fcm is modified, and an attribute weight Wᵢ is added during calculation of the Euclidean distance. By setting the clustering parameters, cluster analysis is performed on the foregoing normalized factors. After processing by MATLAB, the results are post-processed by using the fprintf function. First, parameters such as the x and y coordinates on the left bottom of the grid and the number of lines and columns of the grid which are obtained during file reading are re-written into the header file, and the calculated numerical values regarding the grid are output and then the calculation results are converted into ASCII data. The ASCII file is read by using the ArcGIS software, and is converted into a grid file, to output a zoning map based on the eco-geological environment types, as shown in FIG. 15.

The present invention relates to a method for classifying eco-geological environment types based on coal resource exploitation. This method aims to classify arid and semi-arid regions rich in coal resources but having a fragile eco-geological environment in Northwest China into different eco-geological environment types, and draw a zoning map based on the eco-geological environment types. In the method of the present invention, first, based on surveys of ecological, hydrological, and geological information of an area, factors affecting the eco-geological environment are collected and collated, and are made dimensionless by using a normalization function. Then, a weight coefficient of each factor in its influence on the eco-geological environment is determined by means of an FDAHP. Afterwards, with MATLAB as a computing platform, superimposed clustering computation is performed for the influence factors by means of weighted fuzzy C-means clustering, to obtain three different clustering results. Finally, imaging processing is performed for the clustering results by using ArcGIS, and different eco-geological environment types are determined by analysis on a cluster center value of each factor. According to the existing ecological, hydrological, and geological information, the present invention can rapidly and effectively classify the different eco-geological environment types, and further determine eco-geological features of the different types of the eco-geological environment and their sensitivity to coal resource exploitation. In this way, the present invention provides a scientific basis for selecting an appropriate coal mining mode to realize exploitation and utilization of the coal resource while the valuable phreatic resources in the arid and semi-arid regions are protected and the ecologically fragile environment is maintained, thus being of great significance for coal mining under water-containing condition in the ecologically fragile regions in Northwest China.

The above merely describes a preferred embodiment of the present invention, but the protection scope of the present invention is not limited thereto. Any changes or substitutions easily conceivable by those skilled in the art within the technical scope of the present invention all fall within the protection scope of the present invention.

What is claimed is:

1. A method for classifying eco-geological environment types based on coal resource exploitation, comprising the following steps:
step 1: acquiring ecological, hydrological, and geological information of an area;
step 2: establishing a hierarchical structure model for classification of eco-geological environment types;
step 3: selecting relevant factors affecting an eco-geological environment as a plurality of classification indicators according to the ecological, hydrological, and geological information acquired in step 1 and the hierarchical structure model established in step 2; and acquiring ecological, hydrological, and geological data corresponding to all the plurality of classification indicators participating in a type classification in the hierarchical structure model for a classification of eco-geological environment types of a to-be-classified region;
step 4: converting the ecological, hydrological, and geological data related to the plurality of classification indicators acquired in step 3 into floating-point data;
step 5: making the floating-point data obtained in step 4 dimensionless by using a normalization function;
step 6: analyzing and calculating a weight coefficient of each classification indicator by a Fuzzy Delphi Analytic Hierarchy Process (FDAHP);
step 7: combining dimensionless data obtained in step 5 and the weight coefficient obtained in step 6, and performing a superimposed clustering computation for a plurality of influence factors by a weighted fuzzy C-means clustering; and
step 8: performing analysis and judgment based on the superimposed clustering computation results obtained in step 7 and a plurality of ecological, hydrological, and geological features of the plurality of classification indicators, to determine different eco-geological environment types and obtain a zoning map based on the eco-geological environment types.

2. The method for classifying eco-geological environment types based on coal resource exploitation according to claim 1, wherein the hierarchical structure model described in step 2 comprises a goal layer and an indicator layer, the goal layer indicates a general goal of the classification of eco-geological environment types, and the indicator layer is composed of all the plurality of classification indicators participating in the type classification.

3. The method for classifying eco-geological environment types based on coal resource exploitation according to claim 1, wherein the normalization function for a dimensionless processing in step 5 is as follows:
$${f}_{i} = a + ( b - a ) \frac{{x}_{i} - min ( {x}_{i} )}{max ( {x}_{i} ) - min ( {x}_{i} )} , ( i = 1 , 2 , … n )$$
wherein in the formula, fᵢ is an ith dimensionless data in the each classification indicator; a and b are respectively a lower limit and a upper limit of a normalization range, n pieces of data existing in the each classification indicator; xᵢ is an ith original data before the dimensionless processing in the each classification indicator; and max(xᵢ) and min(xᵢ) are respectively a maximum value and a minimum value of the ith original data in the each classification indicator.

4. The method for classifying eco-geological environment types based on coal resource exploitation according to claim 1, wherein the lower limit a of the normalization range is 0 and the upper limit b of the normalization range is 1.

5. The method for classifying eco-geological environment types based on coal resource exploitation according to claim 1, wherein step 6 is specifically as follows: by consulting a plurality of experts in ecological, hydrological, and geological fields, and by using the FDAHP and a T.L.Saatyl-9 scaling method in combination, scoring the each classification indicator for the each classification indicator's overall importance to the eco-geological environment, establishing a group fuzzy judgment matrix, determining a group fuzzy weight vector, and finally calculating the weight coefficient of the each classification indicator by a single-criterion weight analysis.

6. The method for classifying eco-geological environment types based on coal resource exploitation according to claim 1, wherein step 6 specifically comprises the following steps:
step 6.1: setting a plurality of m classification indicators to be judged and a plurality of n consulting experts in related fields; and by the Delphi expert survey, scoring, under a particular criterion by the plurality of n consulting experts in related fields, the plurality of classification indicators in the indicator layer for relative importance to the goal layer, wherein the relative importance between an ith classification indicator Fᵢ and a jth classification indicator Fⱼ is judged by a kth expert is B_{ij·k}, i=1, 2, . . . m, j=1, 2, . . . m, and k=1, 2 . . . n; and determining a pairwise comparison judgment matrix B(k)=[B_{ij·k}] of the kth expert:
$$B ( k ) = [ {B}_{\text{?}} ] = [ \begin{matrix}B \text{?} & B \text{?} & … & B \text{?} & … & B \text{?} \\ B \text{?} & B \text{?} & … & B \text{?} & … & B \text{?} \\ ⋮ & ⋮ & ⋱ & ⋮ & ⋮ & ⋮ \\ B \text{?} & B \text{?} & … & B \text{?} & … & B \text{?} \\ ⋮ & ⋮ & … & ⋮ & ⋱ & ⋮ \\ B \text{?} & B \text{?} & … & B \text{?} & … & B \text{?}\end{matrix} ] , \\ i = 1 … m , j = 1 … m and k = 1 … n , \\ \text{?} \text{indicates text missing or illegible when filed}$$
wherein B_{ij·k}=P_{i·k}/P_{j·k}, P_{i·k} is a score of the ith classification indicator for importance to the goal layer, wherein the importance is given by the kth expert, and P_{j·k} is a score of the jth classification indicator for importance to the goal layer, wherein the importance is given by the kth expert;
step 6.2: establishing a group pairwise fuzzy judgment matrix C, expressed by using a plurality of triangular fuzzy numbers, of all the plurality of n consulting experts in related fields:
C=[αᵢⱼ,βᵢⱼ,γᵢⱼ]=[B₁,B₂. . . Bₘ]
wherein in the formula, the group pairwise fuzzy judgment matrix is composed of three computing elements: αᵢⱼ, βᵢⱼ, and γᵢⱼ, wherein i=1 . . . m, j=1 . . . m, aᵢⱼ≤βᵢⱼ≤γᵢⱼ, and αᵢⱼ, βᵢⱼ, γᵢⱼ∈[1/9, 1]∪[1, 9]; and the three computing elements αᵢⱼ, βᵢⱼ, and γᵢⱼ are determined by using the following formulas:
$${α}_{i , j} = min ( {B}_{ij} \cdot k ) , k = 1 , 2 , … , n , \\ {β}_{ij} = geomean ( {B}_{ij \cdot k} ) = ( {\prod }_{k = 1}^{m} {B}_{ij \cdot k} ) , k = 1 , 2 , … , n , \\ {γ}_{ij} = max ( {B}_{ij \cdot k} ) , k = 1 , 2 , … , n ,$$
wherein k=1, 2 . . . n, n being the total number of the plurality of n consulting experts in related fields; min(B_{ij·k}) is a minimum value in scores given by all the plurality of n consulting experts in related fields; geomean(B_{ij·k}) is a geometric mean of the scores given by all the plurality of n consulting experts in related fields; and max(B_{ij·k}) is a maximum value in the scores given by all the plurality of n consulting experts in related fields;
step 6.3: for any classification indicator Fᵢ in all the plurality of classification indicators, calculating a process calculation vector rᵢ involved in determining a group fuzzy weight vector:
$${r}_{i} = {( {B}_{i 1} ⊗ {B}_{i 2} ⊗ … ⊗ {B}_{im} )}^{\frac{1}{m}} ,$$
and then
determining the group fuzzy weight vector regarding any classification indicator Fᵢ as follows:
wᵢ=rᵢ⊗(r₁⊕r₂⊕. . . ⊕rₘ)⁻¹,
wherein in the formula, a plurality of symbols ⊗ and ⊕ are respectively multiplication and addition operations of the plurality of triangular fuzzy numbers; and
step 6.4: determining the group fuzzy weight vector regarding any classification indicator Fᵢ as follows:
wᵢ=(wᵢ^{L},wᵢ^{M},wᵢ^{U}),
wherein in the formula, wᵢ^{L}, wᵢ^{M}, and wᵢ^{U} are respectively a minimum value, an intermediate value, and a maximum value in a plurality of group fuzzy weight vector results regarding the ith classification indicator Fᵢ, wherein the plurality of group fuzzy weight vector results are calculated in step 6.3; and then
after normalization processing, determining a weight coefficient Wᵢ of any classification indicator Fᵢ as follows:
$${W}_{i} = \frac{\sqrt[3]{{w}_{i}^{L} \times {w}_{i}^{M} \times {w}_{i}^{U}}}{{\sum }_{i} \sqrt[3]{{w}_{i}^{L} \times {w}_{i}^{M} \times {w}_{i}^{U}}} .$$

7. The method for classifying eco-geological environment types based on coal resource exploitation according to claim 1, wherein step 7 comprises the following steps:
step 7.1: setting a sample collection X to be subjected to the superimposed clustering computation and having n pieces of d-dimensional vector data, wherein X={x₁, x₂, x₃, . . . xₙ}; grouping a sample collection into c clusters Gᵢ(i=1, . . . , c), i being an ith cluster; randomly selecting a plurality of c data points from the sample data as an initial cluster center, and xₖ={xₖ₁, xₖ₂, xₖ₃, . . . , x_{kd}}^{T}∈R^{d}(k=1, . . . c), xₖⱼ being a value assigned to a jth-dimension attribute of a data point xₖ; and setting a plurality of values of a weighted index m, an objective function iteration termination threshold ε, and a maximum number of iterations before termination, 1;
step 7.2: calculating a weighted Euclidean distance d_{w-ij} from each data point in each sample to a cluster center;
step 7.3: calculating a membership degree of data in the each sample with respect to each cluster;
step 7.4: calculating a new cluster center matrix P; and
step 7.5: repeating steps 7.2, 7.3, and 7.4; and for the each data point in each sample indicator, when a difference value between a new cluster center matrix P^{(t)} calculated in a tth iteration and a new cluster center matrix P^{(t+1)} calculated in a (t+1)th iteration is less than a set iteration termination threshold ε, that is, ∥P^{(t+1)}−P^{(t)}∥<ε, or a number of iterations reaches set maximum number 1, stopping calculation.

8. The method for classifying eco-geological environment types based on coal resource exploitation according to claim 1, wherein in step 7.1, the weighted index m is 2, and the iteration termination threshold c is taken from 0.001 to 0.01.

9. The method for classifying eco-geological environment types based on coal resource exploitation according to claim 1, wherein step 7.2 comprises the following sub-steps:
sub-step 7.2.1: grouping the sample collection X={x₁, x₂, x₃, . . . xₙ} having n sample data points xₖ(k=1, . . . , n) into c clusters Gᵢ(i=1, . . . , c); randomly selecting c data points from data points xₖ(k=1, . . . , n) in each sample as the initial cluster center of the each cluster, wherein xₖ={xₖ₁, xₖ₂, xₖ₃, . . . , x_{kd}}^{T}∈R^{d}(k=1, . . . c), and xₖⱼ is a value assigned to the jth-dimension attribute of the data point xₖ; and calculating a distance from each data point in each sample to the initial cluster center cᵢ(i=1, . . . c), and calculating a sum of squared errors (SSE) from a plurality of data points in each sample to the initial cluster center; and
sub-step 7.2.2: multiplying the Euclidean distance dₖᵢ=∥xₖ−cᵢ∥ from each data point in each sample to the cluster center by the weight coefficient Wᵢ calculated in step 6.4, for modification:
Euclidean distance:
$${d}_{ki} = d ( {x}_{k} - {c}_{i} ) = ‖ {x}_{k} - {c}_{i} ‖ = \sqrt{{\sum }_{i = 1}^{d} {( {x}_{ij} - {c}_{ij} )}^{2}} ,$$
and
weighted Euclidean distance: d_{x- ij}=d∥xⱼ−cᵢ∥ᵥ=[(xⱼ−cᵢ)^{T}W²(xⱼ−cᵢ]^{1/2}
wherein a weight vector W consists of the weight coefficient Wᵢ calculated in step 6.4, that is, the weight vector W=[W₁, W₂, . . . Wᵢ]^{T}, (i=1 . . . d), and the weight coefficient Wᵢ in the weight vector shall meet the following formula:
$${W}_{i} \geq 0 , i = \{ 1 , 2 , … , d \} and {\sum }_{i = 1}^{d} {W}_{i} = 1.$$

10. The method for classifying eco-geological environment types based on coal resource exploitation according to claim 1, wherein step 7.3 comprises the following sub-steps:
sub-step 7.3.1: setting a new SSE criterion function for evaluation of clustering performance, namely, a new weighted objective function:
$${J}_{WFCM} = {\sum }_{i = 1}^{c} {\sum }_{j = 1}^{n} {u}_{ij}^{m} {‖ {x}_{j} - {c}_{i} ‖}_{w}^{2} = {\sum }_{i = 1}^{c} {\sum }_{j = 1}^{n} {u}_{ij}^{m} {d}_{w - ij}^{2} ;$$
$$wherein$$
$${u}_{ij} = \{ \begin{matrix}1 & k \neq i , if {‖ {x}_{j} - {c}_{i} ‖}^{2} \leq {‖ {x}_{j} - {c}_{k} ‖}^{2} \\ 0 & under other conditions\end{matrix} ;$$
sub-step 7.3.2: performing a solution calculation by using a Lagrangian multiplier method, to create a new Lagrangian function:
$$\begin{matrix}J ( U , P , {λ}_{1} , … , {λ}_{n} ) = {J}_{WFCM} ( U , P ) + {\sum }_{j = 1}^{n} {λ}_{j} ( {\sum }_{i = 1}^{c} {u}_{ij} - 1 ) \\ = {\sum }_{i = 1}^{c} {\sum }_{j = 1}^{n} {u}_{ij}^{m} {d}_{w - ij}^{2} + {\sum }_{j = 1}^{n} {λ}_{j} ( {\sum }_{i = 1}^{c} {u}_{ij} - 1 ) ,\end{matrix}$$
wherein in the formula, U is a weighted fuzzy partition matrix, P is a new cluster center matrix, uᵢⱼ is a membership degree of a jth data point with respect to a cluster Gᵢ, cᵢ is a cluster center of a corresponding fuzzy vector set, and λⱼ is a Lagrangian multiplier of n constraint formulas; and
with reference to a constraint condition
$${\sum }_{i = 1}^{c} {u}_{ij} = 1 {∀}_{j} = 1 , … n ,$$
calculating a partial derivative for a plurality of input parameters m=2 and 0.001≤ε≤0.01, to obtain a necessary condition for the new weighted objective function J_{WFCM} to reach a minimum value:
$${u}_{\text{?}} = \{ \begin{matrix}\frac{1}{{\sum }_{\text{?}}^{c} ( \frac{d \text{?}}{d \text{?}} )} & d \text{?} > 0 ( 1 \leq j \leq c ) \\ 1 & d \text{?} = 0 ( 1 \leq i \leq c ) \\ 0 & ∃ j , j \neq i , d \text{?} = 0\end{matrix} and {c}_{w - i} = \frac{{\sum }_{j = 1}^{n} {u}_{w - ij}^{m} {x}_{j}}{{\sum }_{j = 1}^{n} {u}_{w - ij}^{m}} ; \\ \text{?} \text{indicates text missing or illegible when filed}$$
and
sub-step 7.3.3: determining a membership degree of a data point with respect to a certain cluster according to a maximum membership principle where the data point belongs to a cluster having a maximum membership degree as shown in the following expression:
$$k = arg {max}_{i = 1 , … , c} {u}_{ij} .$$
